(19) United States
(12) Patent Application Publication
(10) Pub. No.: US 2010/0309376 A1
(43) Pub. Date: Dec. 9, 2010

(54) Multimedia Presenting System, Multimedia Processing Apparatus Thereof, and Method for Presenting Video and Audio Signals

(76) Inventor: Yungchun Lei, Taiwan Hsinchu City (CN)

Correspondence Address: Adli Law Group P.C., 633 West Fifth Street, Suite 2600, Los Angeles, CA, 90071, US

(21) Appl. No.: 12/812,917

(22) PCT Filed: Jan. 15, 2008
(86) PCT No.: PCT/CN08/70114

§ 371 Date: Jul. 14, 2010

(51) Int. Cl. H04N 9/74

(52) U.S. Cl. 348/584; 348/E09.055

(57) ABSTRACT

A multimedia presenting system includes a display apparatus, a sound apparatus, and a multimedia processing unit. The multimedia processing unit includes a processor, a factor generator, and a mixer. The display apparatus displays video signals. The sound apparatus broadcasts audio signals. The processor processes a first video signal related to a first audio signal and a second video signal related to a second audio signal, and obtains presenting information of the first and second video signals on the display apparatus. The factor generator generates a factor according to the presenting information. The mixer adjusts the first and second audio signals according to the factor and mixes the adjusted first and second audio signals.

### CROSS-REFERENCES TO RELATED APPLICATIONS

Not applicable.

### BACKGROUND OF THE INVENTION

1. Field of the Invention

The present invention relates to a multimedia presenting system, a multimedia processing apparatus thereof, and a method for presenting video and audio signals using a factor generated according to the presenting information of the video signals.

2. Descriptions of the Related Art

Multimedia apparatuses have become increasingly popular as they have been further developed over the years. A major improvement is that these apparatuses process not only one single video signal with one audio stream but two or more video signals with a plurality of audio streams. For example, two video signals can be presented on a multimedia apparatus as picture-in picture (PIP) or picture-out-picture (POP).

When presenting two video signals on a multimedia apparatus, their audio streams are also provided at the same time. However, if the multimedia apparatus presents the two audio streams without considering the corresponding presenting region of the video signals on the multimedia apparatus, the sound would be disordered and unpleasant.

Accordingly, an apparatus capable of mixing and broadcasting the audio streams of a plurality of video signals while simultaneously presenting video signals is desired.

### SUMMARY OF THE INVENTION

One objective of this invention is to provide a multimedia processing apparatus for presenting a plurality of video and audio signals. The multimedia processing apparatus comprises a processor, a factor generator, and a mixer. The processor processes a first video signal related to a first audio signal and a second video signal related to a second audio signal, and obtains presenting information of the first and second video signals on a display. The factor generator generates a factor according to the presenting information. The mixer adjusts the first and second audio signals according to the factor and mixes the adjusted first and second audio signals.

Another object of this invention is to provide a method for presenting a plurality of video and audio signals. The method comprises the following steps: processing a first video signal related a first audio signal; processing a second video signal related to a second audio signal; obtaining presenting information of the first and second video signals on a display; generating a factor according to the presenting information; adjusting the first and second audio signals according to the factor; and mixing the adjusted first and second audio signals.

Another objective of this invention is to provide a multimedia presenting system which comprises a display apparatus, a sound apparatus, and a multimedia processing unit. The display apparatus displays video signals. The sound apparatus broadcasts audio signals. The multimedia processing unit processes a first video signal related to a first audio signal and a second video signal related to a second audio signal, and obtains presenting information of the first and second video signals on the display apparatus. The processing unit also generates a factor according to the presenting information. Finally, the first and second audio signals are adjusted according to the factor and mixed after being adjusted by the multimedia processing unit.

The present invention broadcasts audio signals using a factor when the video signals are simultaneously presented. The factor is generated according to the presenting information, such as a position and/or a size of presenting regions of the video signals so that the audio signals can be mixed and broadcasted in an appropriate manner associating with the video signals.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating a first embodiment of the present invention;

FIG. 2A is a schematic diagram illustrating the presenting regions of video signals in PIP mode;

FIG. 2B is a schematic diagram illustrating the presenting regions of video signals in POP mode; and

FIG. 3 is a flow chart illustrating a second embodiment of the present invention.

### DESCRIPTION OF THE PREFERRED EMBODIMENT

In this specification, the term “according to” is defined as “replying to” or “reacting to.” For example, “according to a signal” means “replying to a signal” or “reacting to a signal” without necessity of direct signal reception. The term “in response to” has a definition similar to that of the term “according to.”

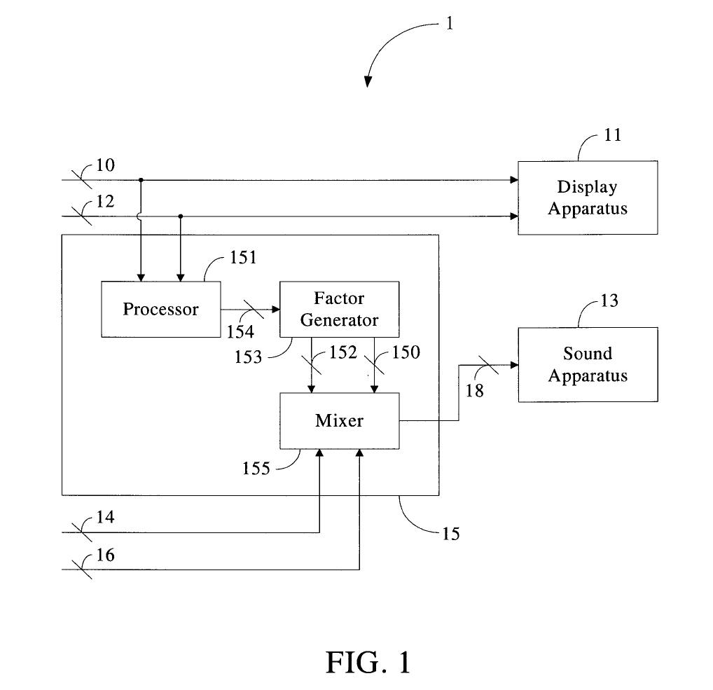

As shown in FIG. 1, the first embodiment of the present invention discloses a multimedia presenting system 1 for presenting a plurality of video and audio signals. The multimedia presenting system 1 comprises a display apparatus 11, a sound apparatus 13, and a multimedia processing unit 15. The display apparatus 11 displays video signals, such as TV signals, digital video signals, and other kinds of video signals. In this embodiment, the display apparatus 11 displays a first video signal 10 and a second video signal 12. The two video signals may be from different sources. For example, the first video signal 10 may be a TV signal, while the second video signal 12 is a DVD signal. The sound apparatus 13 broadcasts audio signals associated with the video signals. The multimedia processing unit 15 comprises a processor 151, a factor generator 153, and a mixer 155.

The processor 151 processes the first video signal 10 and the second video signal 12 to generate presenting information 154 corresponding to positions and/or sizes of the presenting regions of the first video signal 10 and second video signal 12 on the display apparatus 11. The factor generator 153 generates a mixing factor 150 for adjusting a first audio signal 14 associated with the first video signal 10 and a second audio signal 16 associated with the second video signal 12 according to the presenting information 154 corresponding to positions and/or sizes of the presenting regions of the first video signal 10 and second video signal 12 on the display apparatus 11. The audio signals 14 and 16 may be multi-channel audio signals including a plurality of sounds, such as a left-channel, right-channel sound, or multi-channels signals sounds. More specifically, the presenting region of a video signal comprises size and position information of the video signal for adjusting a corresponding audio signal. For example, the mixing factor 150 may correspond to the presenting region size. When the first video signal 10 acquires a larger area than that of the second video signal 12 on the display apparatus 11, the mixing factor 150 is provided to the mixer 155 from the factor generator 153, allowing first audio signal 14 to have a larger amplitude than that of the second audio signal 16. The mixer 155 then mixes the adjusted first audio signal 14 and second audio signal 16 to generate a mixed audio signal 18 according to the mixing factor 150. Similarly, the mixing factor 150 may correspond to the present region positions of the video signals on the display apparatus 11. For example, when the first video signal 10 presents on a right-hand part of the display apparatus 11, the mixer 155 is provided to allow the first audio signal 14 to have a larger volume on a right sound channel.

In addition, the factor generator 153 also can generate a filtering factor 152 according to the presenting information 154 corresponding to positions and/or sizes of the presenting regions of the first video signal 10 presented on the display apparatus 11, as well as the presenting information 154 corresponding to positions and/or sizes of the presenting regions of the second video signal 12 presented on the display apparatus 11 at the same time. For example, the filtering factor 152 corresponds to the virtual positions of objects in an image formed by the video signal, wherein the objects may be a person or a car, with each in a different position in the image. The virtual positions indicate positions of the virtual surround sound of an object in the image. With the virtual position information of video signals, the displaying sound of each object in a video signal, contained in the corresponding audio signal, would be processed as if the objects are in different positions in front of the user. When the position of the object moves in the image, the positions of the virtual surround sound with respect to the object vary according to the movement of the object, so that the multimedia presenting system 1 can present the virtual position of the object without the large number of speakers that are traditionally required for presenting surrounding sound effect. The mixer 155 mixes the first audio signal 14 and the second audio signal 16 to generate a mixed audio signal 18 according to the filtering factor. In this case, the mixer can be an infinite impulse response (IIR) filter, a finite impulse response (FIR) filter, or another kind of digital filter.

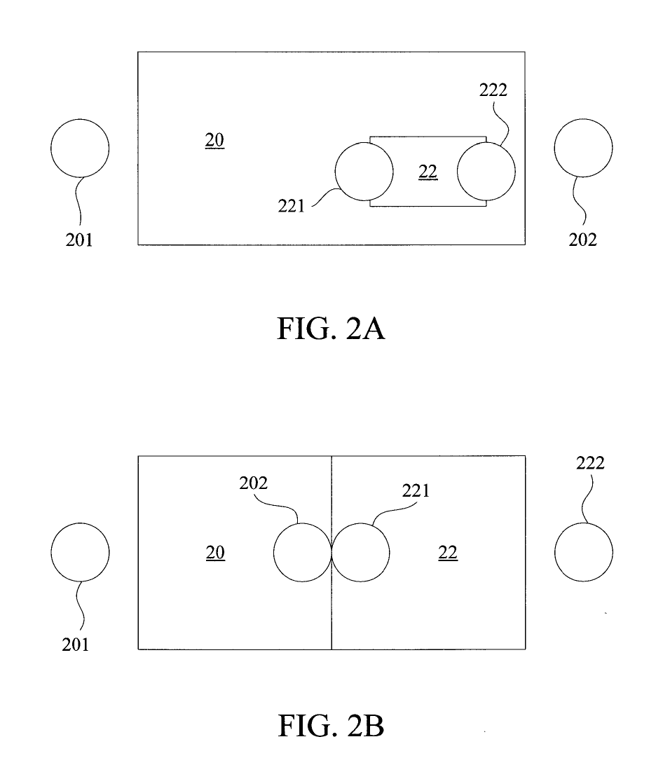

In this embodiment, the first audio signal 14 and the second audio signal 16 further comprise a left-channel and a right-channel audio signal. FIG. 2A illustrates the presenting regions of the first video signal 10 and the second video signal 12 when the first video signal 10 and the second video signal 12 are presented in PIP mode. FIG. 2B illustrates the presenting regions of the first video signal 10 and the second video signal 12 when the first video signal 10 and the second video signal 12 are presented in picture-outside-picture (POP) mode. The first video signal 10 is presented in the presenting region 20 of FIGS. 2A and 2B. The left-channel audio signal of the first audio signal 14 is ready for broadcast at a virtual position 201 according to the presenting region 20, while the right-channel audio signal of the first audio signal 14 is ready for broadcast at a virtual position 202 according to the presenting region 20. The second video signal 12 is presented on the presenting region 22 in FIGS. 2A and 2B. The left-channel audio signal of the second audio signal 16 can be broadcasted at a virtual position 221 according to the presenting region 20, while the right-channel audio signal of the second audio signal 16 can be broadcasted at a virtual position 222 according to the presenting region 20.

Since the presenting region 22 is smaller than the present region 20 in FIG. 2A, the amplitude of the first audio signal 14 is processed to be larger than that of the second audio signal 16. The two audio signals are then mixed for presentation. In FIG. 2B, the presenting areas 20 and 22 are about equal; therefore, the amplitudes of the first audio signal 14 and second audio signal 16 are processed to be equal. The two audio signals 14 and 16 are then mixed for presentation.

The present invention is not limited to the number of audio channels of the first audio signal 14 and the second audio signal 16. In other words, the first audio signal 14 and the second audio signal 16 are multi-channel audio signals associated with the first video signal 10 and the second video signal 12, respectively. For example, the first audio signal 14, as well as the second audio signal 16, can be a 5.1, 6.1, or 7.1 channel audio signal. Meanwhile the display apparatus can be a TV, a LCD, a projector, or any other kind of display apparatuses.

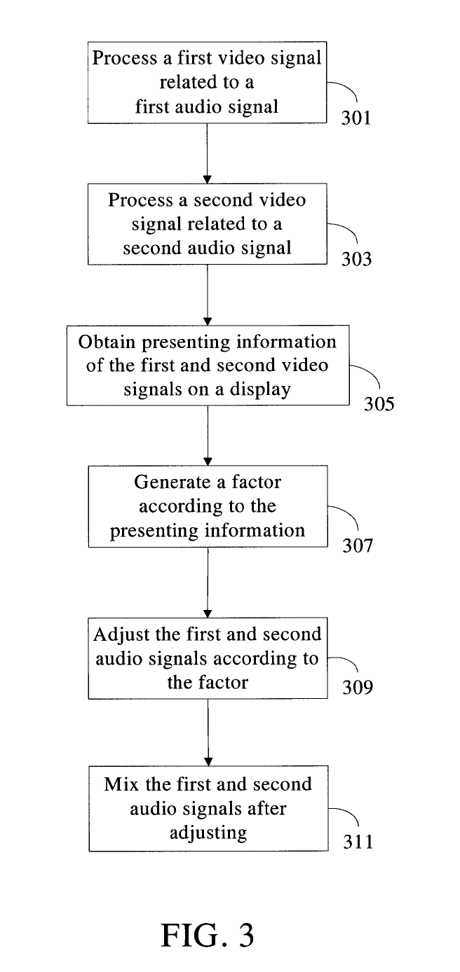

A second embodiment of the present invention is a method for presenting a plurality of video and audio signals. The second embodiment corresponds to the first embodiment. In particular, the second embodiment may be performed by the system of the first embodiment. As shown in FIG. 3, the second embodiment comprises the following steps. In step 301, a first video signal associated with a first audio signal is processed. Step 303 is then executed in which a second video signal associated with a second audio signal is processed. In step 305, presenting information of the first and second video signals on a display is obtained. In step 307, a factor is generated according to the presenting information. The generation of the mixing factor and filtering factor has been discussed previously and is thus not further described. In step 309, the first and second audio signals are adjusted according to the factor. In step 311, the first and second audio signals are mixed after adjusting.

In the second embodiment, the numbers of sound channels of the first audio signal and the second audio signal are not limited. In other words, the first and second audio signals are multi-channel sound signals associated with the first and second video signals, respectively. For example, either the first or second audio signals can be 2 (a left-channel and a right-channel), 5.1, 6.1, or 7.1 channels audio signal.

Accordingly, the invention broadcasts audio signals by a mixing factor or a filtering factor when the video signals are presented simultaneously. The mixing factor or the filtering factor is generated according to the presenting regions of the video signals. The audio signals are further mixed and broadcasted.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A multimedia processing apparatus for presenting a plurality of video signals and audio signals, comprising:
a processor for processing a first video signal related to a first audio signal and a second video signal related to a second audio signal and obtaining presenting information of the first and second video signals on a display;
a factor generator for generating a factor according to the presenting information; and
a mixer for adjusting the first and second audio signals according to the factor and mixing the adjusted first and second audio signals.

2. The multimedia processing apparatus as claimed in claim 1, wherein the presenting information is size or position information of presenting regions of a corresponding video signal on the display.

3. The multimedia processing apparatus as claimed in claim 1, wherein the audio signals are multi-channel sound signals.

4. The multimedia processing apparatus as claimed in claim 1 wherein each of the audio signals comprises a left-channel sound signal and a right-channel sound signal.

5. The multimedia processing apparatus as claimed in claim 4, wherein the mixer adjusts the left-channel and right-channel sound signals of the first and second audio signals according to the factor corresponding to a position of presenting regions of the first and second video signals on the display respectively.

6. The multimedia processing apparatus as claimed in claim 1, wherein the mixer adjusts amplitudes of the first and second audio signals according to the factor corresponding to a size of presenting regions of the first and second video signals on the display respectively.

7. The multimedia processing apparatus as claimed in claim 1, wherein the first video signal forms a first image containing a first object, the second video signal forms a second image containing a second object, and the presenting information corresponds to a position of the first object in the first image and a position of the second object in the second image.

8. A method for presenting a plurality of video signals and audio signals, comprising the steps of:
processing a first video signal related to a first audio signal;
processing a second video signal related to a second audio signal;
obtaining presenting information of the first and second video signals on a display;
generating a factor according to the presenting information;
adjusting the first and second audio signals according to the factor; and
mixing the adjusted first and second audio signals.

9. The method as claimed in claim 8, wherein the presenting information is size or position information of presenting regions of a corresponding video signal on the display.

10. The method as claimed in claim 8, wherein the audio signals are multi-channel sound signals.

11. The method as claimed in claim 8, wherein each of the audio signals comprises a left-channel sound signal and a right-channel sound signal.

12. The method as claimed in claim 11, wherein the step of adjusting the first and second audio signals comprises adjusting the left-channel and right-channel sound signals of the first and second audio signals according to the factor corresponding to a position of presenting regions of the first and second video signals on the display respectively.

13. The method as claimed in claim 8, wherein the step of adjusting the first and second audio signals comprises adjusting amplitudes of the first and second audio signals according to the factor corresponding to a size of presenting regions of the first and second video signals on the display respectively.

14. The method as claimed in claim 8, wherein the first video signal forms a first image containing a first object, the second video signal forms a second image containing a second object, and the presenting information corresponds to a position of the first object in the first image and a position of the second object in the second image.

15. A multimedia presenting system, comprising:
a display apparatus for displaying a plurality of video signals;
a sound apparatus for broadcasting a plurality of audio signals; and
a multimedia processing unit for processing a first video signal related to a first audio signal and a second video signal related to a second audio signal, and obtaining presenting information of the first and second video signals on the display apparatus;
wherein the multimedia processing unit further generates a factor according to the presenting information, adjusts the first and second audio signals according to the factor and mixes the adjusted first and second audio signals.

16. The multimedia presenting system as claimed in claim 15, wherein the presenting information is size or position information of presenting regions of a corresponding video signal on the display apparatus.

17. The multimedia presenting system as claimed in claim 15, wherein each of the audio signals comprises a left-channel sound signal and a right-channel sound signal.

18. The multimedia presenting system as claimed in claim 17, wherein the multimedia processing unit adjusts the left-channel and right-channel sound signals of the first and second audio signals according to the factor corresponding to a position of presenting regions of the first and second video signals on the display apparatus respectively.

19. The multimedia presenting system as claimed in claim 15, wherein the multimedia processing unit adjusts amplitudes of the first and second audio signals according to the factor corresponding to a size of presenting regions of the first and second video signals on the display apparatus respectively.

20. The multimedia presenting system as claimed in claim 15, wherein the first video signal forms a first image containing a first object, the second video signal forms a second image containing a second object, and the presenting information corresponds to a position of the first object in the first image and a position of the second object in the second image.

21. The multimedia presenting system as claimed in claim 15, wherein the display apparatus is one of a TV, a LCD, and a projector.
